(19) United States
(12) Patent Application Publication
(10) Pub. No.: US 2013/0280557 A1
(43) Pub. Date: Oct. 24, 2013

(54) ULTRASONIC RECHARGEABLE BATTERY MODULE AND ULTRASONIC RECHARGEABLE BATTERY APPARATUS OF POLYHEDRAL STRUCTURE INCLUDING THE SAME

(71) Applicant: Electronics and Telecommunications Research Institute, (US)

(72) Inventors: Sung Q LEE, Daejeon (KR); Gunn HWANG, Daejeon (KR); WooSub YOUM, Daejeon (KR)

(73) Assignee: Electronics and Telecommunications Research Institute, Daejeon (KR)

(21) Appl. No.: 13/843,689

(22) Filed: Mar. 15, 2013

(30) Foreign Application Priority Data
Apr. 24, 2012 (KR) 10-2012-0042714
Nov. 21, 2012 (KR) 10-2012-0132205

(51) Int. Cl. H01M 10/46

(52) U.S. Cl. CPC H01M 10/46
USPC 429/4

(57) ABSTRACT

The present disclosure relates to an ultrasonic rechargeable battery module and an ultrasonic rechargeable battery apparatus of a polyhedral structure including the same. The ultrasonic rechargeable battery module includes: a packaging including an accommodation part; a reception vibration panel coupled to a peripheral portion of the packaging by using a flexible hinge to seal the packaging; an ultrasonic wave receiving element formed in a lower surface of the reception vibration panel, and configured to convert vibration energy generated by ultrasonic waves to electric energy; a circuit board formed inside the packaging, and configured to convert the electric energy converted by the ultrasonic wave receiving element to electric energy having a predetermined size; and a secondary battery formed inside the packaging and configured to store the electric energy converted by the circuit board, in which the packaging, the flexible hinge, and the reception vibration panel are formed of a titanium alloy.

### CROSS-REFERENCE TO RELATED APPLICATIONS

This application is based on and claims priority from Korean Patent Application Nos. 10-2012-0042714, filed on Apr. 24, 2012, and 10-2012-0132205, filed on Nov. 21, 2012, with the Korean Intellectual Property Office, the disclosure of which is incorporated herein in its entirety by reference.

### TECHNICAL FIELD

The present disclosure relates to an ultrasonic rechargeable battery module capable of wirelessly transmitting electric energy from the outside to the inside of a human body by using ultrasonic waves passing through skin, panniculus carnosus, or panniculus adiposus that is a representative human tissue and charging a secondary battery with the transmitted electric energy, to use the secondary battery as an independent battery module, and more particularly to, an ultrasonic rechargeable battery module having a packaging structure appropriate for a human, having a device structure in which energy transmission efficiency is not decreased according to the packaging, and having smoothly arranged electrode wirings therein, and an ultrasonic rechargeable battery apparatus of a polyhedral structure including the same.

### BACKGROUND

U.S. Pat. No. 6,798,716 B1 (System and Method for wireless electrical power transmission, Arthur Charych, BC System Inc.) discloses a method of wirelessly transmitting power (energy) by using ultrasonic waves. The US patent discloses a method of arranging ultrasonic wave generating devices and collecting beams to the center by controlling phases of the arranged ultrasonic generating devices, and a method of adjusting directions of the beams through the control of the phases of the arranged ultrasonic wave generating devices.

US Patent Application No. 2010/0164433A1 (Wireless Battery Charging Systems, Battery Systems and Charging apparatus, Anand Janefalkar, Motorola Inc.) discloses a portable terminal charging a battery by using an ultrasonic wave generating device.

The aforementioned patents disclose a technology of wireless power transmission technology using ultrasonic waves, but do not disclose a detailed technology for an ultrasonic wave reception apparatus having a structure appropriate for and insertable in a human body. That is, in order to achieve the ultrasonic wave reception apparatus having the structure appropriate for and insertable in a human body, a packaged material needs to be appropriate for a human body, and a vibration energy decrease effect by the packaging when vibration energy is transmitted needs to be small. In this respect, Korean Patent Application No. 10-2005-0062897 (Ultrasonic Distance Measuring Apparatus) discloses an ultrasonic distance measuring apparatus used for generally measuring a distance based on a high directivity structure having a concave shape, but does not consider packaging for insertion in the human body.

### SUMMARY

The present disclosure has been made in an effort to provide an ultrasonic rechargeable battery module appropriate for and insertable in a human body, and an ultrasonic rechargeable battery apparatus of a polyhedral structure including the same.

The present disclosure has also been made in an effort to provide an ultrasonic rechargeable battery module of which energy conversion performance is not influenced by packaging, and an ultrasonic rechargeable battery apparatus of a polyhedral structure including the same.

The present disclosure has also been made in an effort to provide an ultrasonic rechargeable battery module, in which an internal circuit and a piezoelectric element are easily connected, thereby having no difficulty in manufacturing, and an ultrasonic rechargeable battery apparatus of a polyhedral structure including the same.

An exemplary embodiment of the present disclosure provides an ultrasonic rechargeable battery module, including: a packaging including an accommodation part; a reception vibration panel coupled to a peripheral portion of the packaging by using a flexible hinge to seal the packaging; an ultrasonic wave receiving element formed in a lower surface of the reception vibration panel, and configured to convert vibration energy generated by ultrasonic waves to electric energy; a circuit board formed inside the packaging, and configured to convert the electric energy converted by the ultrasonic wave receiving element to electric energy having a predetermined size; and a secondary battery formed inside the packaging and configured to store the electric energy converted by the circuit board, in which the packaging, the flexible hinge, and the reception vibration panel are formed of a titanium alloy.

The ultrasonic wave receiving element may include: a piezoelectric element configured to convert vibration energy generated by ultrasonic waves to electric energy; and a matching layer configured to assist vibration of the piezoelectric element through impedance matching.

A strain in a longitudinal direction of the flexible hinge and a strain in a translational direction of the flexible hinge may be determined by a Poission's ratio of the piezoelectric element.

When the reception vibration panel is in direct contact with the piezoelectric element, the reception vibration panel may be used as an electrode.

When the matching layer is a nonconductor, the reception vibration panel and the piezoelectric element may be electrically connected by using an electric wire having a spring structure passing through a hole formed at a center of the matching layer.

The flexible hinge may have a curvature shape or a zigzag shape.

The circuit board may include: a charging circuit unit configured to convert the electric energy converted by the ultrasonic wave receiving element to electric energy having a predetermined size; an overcharge prevention circuit unit configured to prevent the secondary battery from being overcharged; and a MICOM unit configured to transmit voltage information containing a voltage charged in the secondary battery and an amount of voltage charged in the secondary battery by using ultrasonic waves.

The charge circuit unit may include: a rectifier circuit configured to rectify the electric energy converted by the ultrasonic wave receiving element; and a converter circuit configured to maintain the electric energy rectified by the rectifier circuit as electric energy having a predetermined size.

Another exemplary embodiment of the present disclosure provides an ultrasonic rechargeable battery apparatus of a polyhedral structure, including: a polyhedral structure in which an ultrasonic rechargeable battery module is formed in at least one surface, in which the ultrasonic rechargeable battery module includes: a packaging including an accommodation part; a reception vibration panel coupled to a peripheral portion of the packaging by using a flexible hinge to seal the packaging; an ultrasonic wave receiving element formed in a lower surface of the reception vibration panel, and configured to convert vibration energy generated by ultrasonic waves to electric energy; a circuit board formed inside the packaging, and configured to convert the electric energy converted by the ultrasonic wave receiving element to electric energy having a predetermined size; and a secondary battery formed inside the packaging and configured to store the electric energy converted by the circuit board, in which the packaging, the flexible hinge, and the reception vibration panel are formed of a titanium alloy.

The ultrasonic wave receiving element may include: a piezoelectric element configured to convert vibration energy generated by ultrasonic waves to electric energy; and a matching layer configured to assist vibration of the piezoelectric element through impedance matching.

A strain in a longitudinal direction of the flexible hinge and a strain in a translational direction of the flexible hinge may be determined by a Poission's ratio of the piezoelectric element.

The flexible hinge may have a curvature shape or a zigzag shape.

The polyhedral structure may further include an ultrasonic sensor configured to measure specific information by using ultrasonic waves in at least one surface thereof.

The polyhedral structure may further include an ultrasonic communication module configured to perform communication by using ultrasonic waves in at least one surface thereof.

Accordingly, as described above, the present disclosure provides the ultrasonic rechargeable battery module including the ultrasonic wave receiving element, the circuit board, and the secondary battery which are packaged into one unit by using a titanium alloy, and the ultrasonic rechargeable battery apparatus of the polyhedral structure including the same, thereby providing a wireless rechargeable battery module using ultrasonic waves, and appropriate for and insertable in a human body, and optimizing performance of the ultrasonic wave receiving element for converting ultrasonic waves to electric energy.

The present disclosure provides the ultrasonic rechargeable battery module using the titanium alloy with which the ultrasonic wave receiving element, the circuit board, and the secondary battery are packaged as an electrode, and the ultrasonic rechargeable battery apparatus of the polyhedral structure including the same, so that the piezoelectric element included in the ultrasonic wave receiving element is easily electrically connected with an internal circuit, thereby providing a wireless rechargeable battery module smoothly insertable inside a human body.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1 and 2 are an exploded perspective view and a cross-sectional view illustrating a configuration of an ultrasonic rechargeable battery module according to an exemplary embodiment of the present disclosure, respectively.

FIG. 3 is a view for describing a relation between a strain ratio of a flexible hinge and a Poission's ratio of a piezoelectric element.

FIG. 4 is a view illustrating various shapes and a strain combination of the flexible hinge.

FIG. 5 is a cross-sectional view illustrating a configuration of an ultrasonic rechargeable battery module according to another exemplary embodiment of the present disclosure.

FIGS. 6 and 7 are a perspective view and a cross-sectional view illustrating a configuration of an ultrasonic rechargeable battery apparatus of a polyhedral structure including an ultrasonic rechargeable battery module according to yet another exemplary embodiment of the present disclosure, respectively.

FIG. 8 is a view illustrating an application example of the ultrasonic rechargeable battery module according to the exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, an exemplary embodiment according to the present disclosure will be described in detail with reference to the accompanying drawings. A detailed explanation of known related functions and constitutions may be omitted when it is determined that the detailed explanation obscures the subject matter of the present disclosure.

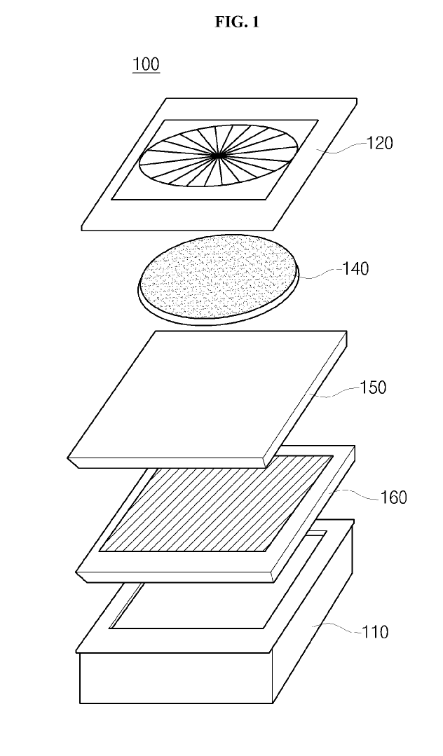

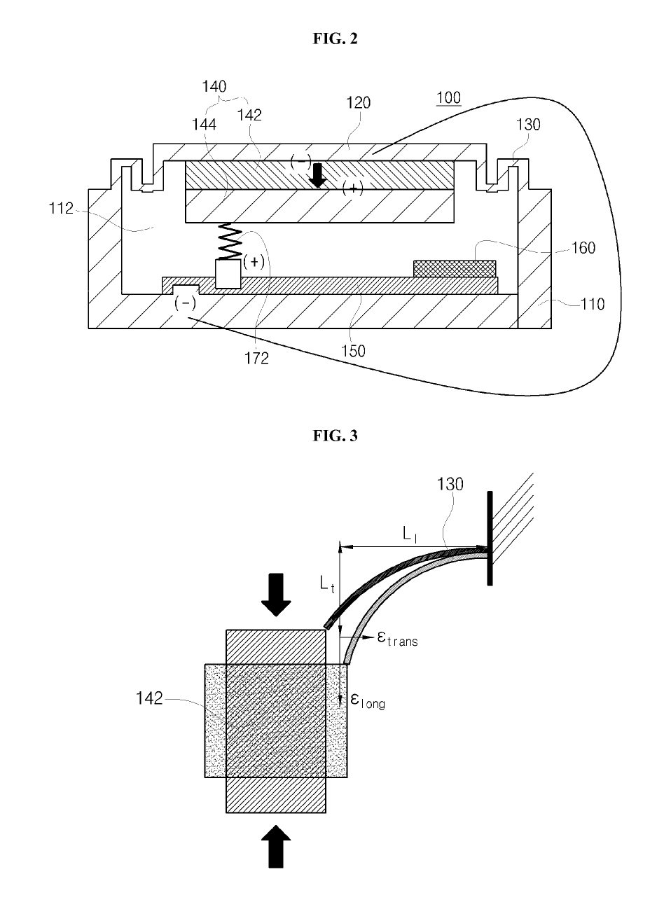

FIGS. 1 and 2 are an exploded perspective view and a cross-sectional view illustrating a configuration of an ultrasonic rechargeable battery module according to an exemplary embodiment of the present disclosure, respectively.

Referring to FIGS. 1 and 2, the ultrasonic rechargeable battery module 100 according to the present disclosure includes a packaging 110, a reception vibration panel 120, a flexible hinge 130, an ultrasonic wave receiving element 140, a circuit board 150, a secondary battery 160, and the like.

The packaging 110 includes an accommodation part 112 for accommodating the circuit board 150, the secondary battery 160, and the like, and is formed of a titanium alloy excellently appropriate for a human body.

The reception vibration panel 120 is coupled to a peripheral portion of the packaging 110 by using the flexible hinge 130 to seal the packaging 110. The reception vibration panel 120 is formed of a titanium alloy, like the packaging 110.

The ultrasonic rechargeable battery module 100 according to the present disclosure includes the flexible hinge 130 enabling a piezoelectric material to smoothly vibrate so that ultrasonic waves are smoothly transmitted to the piezoelectric element inside the packing even though the ultrasonic rechargeable battery module 100 is packaged by using a titanium alloy material. The flexible hinge 130 is formed of a titanium alloy, and connects the packaging 110 and the reception vibration panel 120.

As illustrated in FIG. 3, a piezoelectric element 142 to be described below is contracted or expanded while having a Poission's ratio that is an inherent value of the material when vertically vibrating. The Poission's ratio of the piezoelectric element 142 is defined by a ratio of a strain extended in a translational direction to a strain extended in a longitudinal direction as expressed in Equation 1 below.

ν=εₜᵣₐₙₛ/ε_{long} [Equation 1]

The Poission's ratio is various from 0.15 to 0.48 according to a material of the piezoelectric element 142 (hereinafter, referred to as a “piezoelectric material”). The Poission's ratio of the piezoelectric element is approximately 0.34. Accordingly, when the flexible hinge 130 according to the present disclosure is formed based on the Poission's ratio generated during the vibration, it is possible to optimize performance of the ultrasonic wave receiving element 140 for converting ultrasonic energy to electric energy. When it is generally assumed that the flexible hinge 130 is a thin plate, stiffness of the plate is proportional to 3 squares of the strain as expressed in Equation 2.

K_{stiffness}˜(3EI/L³) [Equation 2]

A relation between the Poission's ratio and the strains in the longitudinal direction and the translational direction of the flexible hinge 130 is obtained as Equation 3. When the flexible hinge 130 satisfying Equation 3 is formed, it is possible to optimize performance of an ultrasonic wireless rechargeable module packaged with the titanium alloy.

$$\begin{matrix}v = {K}_{long} / {K}_{trans} \\ = ( 3 EI / {L}_{l}^{3} ) / ( 3 EI / {L}_{t}^{3} ) \\ = {( {L}_{t} / {L}_{l} )}^{3}\end{matrix} \qquad [ Equation 3 ]$$

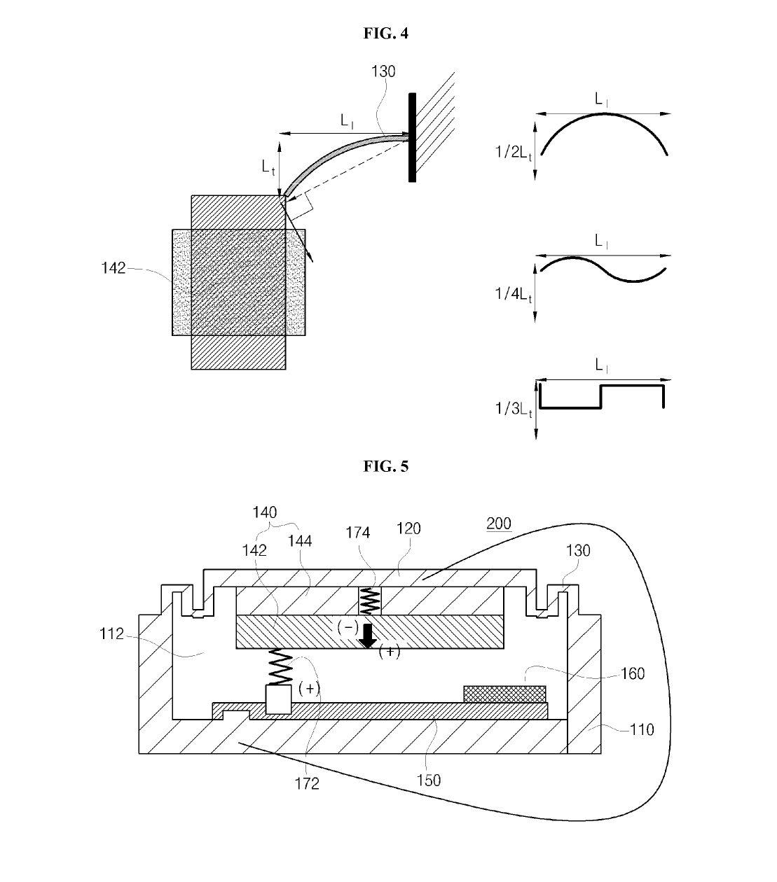

As illustrated in FIG. 4, in a structure in which L₁ determining stiffness in the longitudinal direction is fixed, the strain in the translational direction may be variously combined in order to adjust stiffness in the translational direction according to the Poission's ratio.

Accordingly, when the flexible hinge 130 according to the present disclosure meets Equation 3, the flexible hinge 130 may be implemented in various shapes, such as a curvature shape or a zigzag shape, and even though the flexible hinge 130 has various shapes, the flexible hinge 130 is driven by the same principle.

The ultrasonic wave receiving element 140 is formed at a lower surface of the reception vibration panel 120 to receive ultrasonic waves from an external ultrasonic wave transmitting device, and convert vibration energy generated by the ultrasonic waves to electric energy. To this end, the ultrasonic wave receiving element 140 includes the piezoelectric element 142 for converting vibration energy generated by the ultrasonic waves to electric energy, and a matching layer 144 assisting vibration of the piezoelectric element 142 through impedance matching. As illustrated in FIG. 2, when the piezoelectric element 142 and the matching layer 144 are sequentially stacked so that the reception vibration panel 120 is in direct contact with the piezoelectric element 142, the reception vibration panel 120 may be used as an electrode because the reception vibration panel 120 is formed of a titanium alloy. In this case, the matching layer 144 is formed of a material having high impedance, preferably a material having a metallic property, to be used as an electrode.

The circuit board 150 is formed inside the packaging 110, and converts the electric energy converted by the ultrasonic wave receiving element 140 to electric energy having a predetermined size. To this end, the circuit board 150 may include a charging circuit unit including a rectifier circuit 152 for rectifying the electric energy converted by the ultrasonic wave receiving element 140 and a converter circuit 154 for maintaining the electric energy rectified by the rectifier circuit 152 as electric energy having a predetermined size (for example, 4.0 to 4.5V in a case of a 4V level). Here, the rectifier circuit 152 is a full bridge rectifier.

The circuit board 150 may further include an overcharge prevention circuit unit (not illustrated) for preventing the secondary battery 160 from being overcharged, and a MICOM unit (not illustrated) for transmitting voltage information containing a voltage charged in the secondary battery 160 and an amount of voltage charged in the secondary battery 160 to an external device by using ultrasonic waves.

The circuit board 150 is electrically connected with the matching layer 144 by using an electric wire 172 having a spring structure.

The secondary battery 160 is formed inside the packaging 110, and stores the electric energy converted by the circuit board 150.

Accordingly, the ultrasonic wave receiving element 140, the circuit board 150, and the secondary battery 160 in the ultrasonic rechargeable battery module 100 according to the present disclosure are implemented in a form of one packaging by using the packaging 110 and the reception vibration panel 120.

When a wireless power receiving apparatus using an electromagnetic resonance method in the related art is packaged with a titanium alloy material, electromagnetic waves are not transmitted to the inside thereof, so that power reception itself is difficult. However, since the ultrasonic rechargeable battery module 100 according to the present disclosure uses ultrasonic waves, even though the ultrasonic rechargeable battery module 100 is packaged with a titanium alloy material, vibration energy generated by the ultrasonic waves may be transmitted up to the piezoelectric element 142 included inside the packaging through skin.

FIG. 5 is a cross-sectional view illustrating a configuration of an ultrasonic rechargeable battery module according to another exemplary embodiment of the present disclosure.

Referring to FIG. 5, in the ultrasonic rechargeable battery module 100 according to another exemplary embodiment of the present disclosure, the matching layer 144 is positioned on the piezoelectric element 142. In this case, when the matching layer 144 is an electrical conductor, the matching layer 144 may be directly connected with the reception vibration panel 120 to be used. However, when the matching layer 144 is an electrical nonconductor, the reception vibration panel 120 and the piezoelectric element 142 are electrically connected by using the electric wire 174 having the spring structure passing through a hole formed at a center of the matching layer 144.

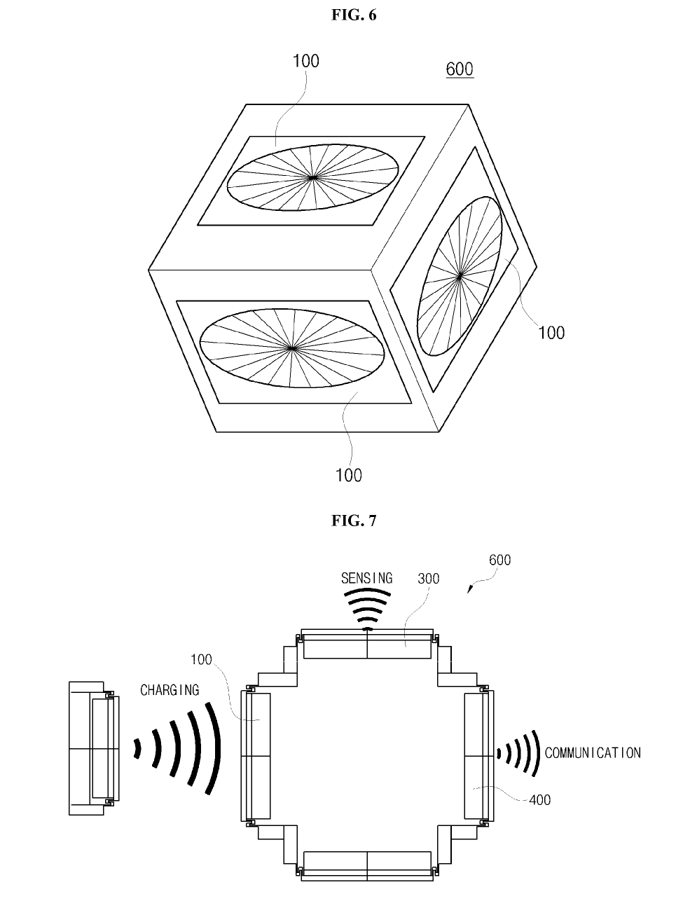

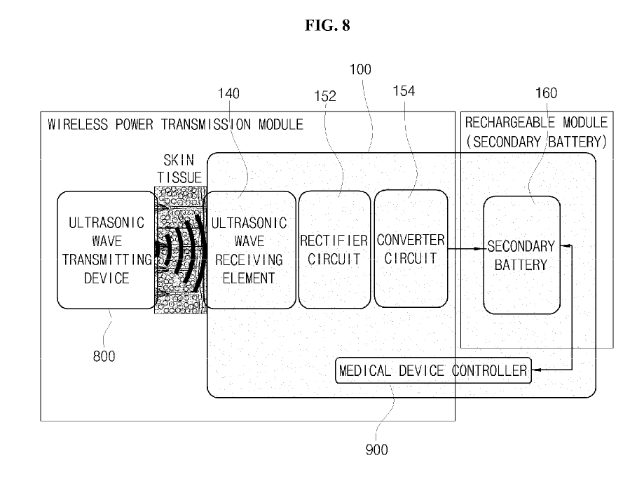

FIGS. 6 and 7 are a perspective view and a cross-sectional view illustrating a configuration of an ultrasonic rechargeable battery apparatus of a polyhedral structure including an ultrasonic rechargeable battery module according to yet another exemplary embodiment of the present disclosure, respectively.

When an ultrasonic wave generating apparatus generates ultrasonic waves in a predetermined direction, a surface in which the ultrasonic waves are received may be changed. Accordingly, an ultrasonic rechargeable battery apparatus of a polyhedral structure capable of receiving ultrasonic waves in multiple surfaces, not receiving ultrasonic waves in one surface, for freedom of directionality of a surface in which the ultrasonic waves are received, may be considered.

As illustrated in FIG. 6, in an ultrasonic rechargeable battery apparatus 600 of a polyhedral structure according to the present disclosure, an ultrasonic rechargeable battery module is mounted in at least one surface of a polyhedral structure. The ultrasonic rechargeable battery apparatus 600 of the polyhedral structure may select the largest electric energy among electric energy generated in the plurality of ultrasonic rechargeable battery modules and store the selected electric energy, or store all of the electric energy generated in the plurality of ultrasonic rechargeable battery modules. The ultrasonic rechargeable battery apparatus 600 of the polyhedral structure may elect the largest electric energy among electric energy generated in the plurality of ultrasonic rechargeable battery modules and store the selected electric energy.

As illustrated in FIG. 7, respective surfaces of the ultrasonic rechargeable battery apparatus 600 of the polyhedral structure according to the present disclosure may be functionally separated to be used. For example, in the ultrasonic rechargeable battery apparatus 600 of the polyhedral structure, the ultrasonic rechargeable battery module 100 for converting ultrasonic waves transmitted from the outside to electric energy to charge may be mounted in one surface, an ultrasonic sensor 300 for measuring a distance, or measuring blood flow inside the human body or blood pressure by using ultrasonic waves may be mounted in another surface, and an ultrasonic communication module 400 for transmitting information on a charge stating inside the ultrasonic rechargeable battery module or sensing information measured by using the ultrasonic sensor to the outside by using ultrasonic waves as a carrier frequency may be mounted in yet another surface.

FIG. 8 is a view illustrating an application example of the ultrasonic rechargeable battery module according to the exemplary embodiment of the present disclosure.

As illustrated in FIG. 8, an ultrasonic wave transmitting device 800 is positioned outside the human body to convert electric energy to ultrasonic waves.

The ultrasonic rechargeable battery module 100 according to the present disclosure includes the ultrasonic wave receiving element 140 for converting the ultrasonic waves received from the ultrasonic wave transmitting device 800 to electric energy, the rectifier circuit 152 for rectifying the electric energy converted by the ultrasonic wave receiving element 140, the converter circuit 154 for maintaining the electric energy rectified by the rectifier circuit 152 as electric energy having a predetermined size, and the secondary battery 160 for storing the electric energy maintained by the converter circuit 154. Here, the ultrasonic wave receiving element 140, the rectifier circuit 152, the converter circuit 154, and the secondary battery 160 may be packaged into one unit by using a titanium alloy. The electric energy stored in the secondary battery 160 may be used for controlling a medical device by a medical device controller 900 later.

Accordingly, the ultrasonic rechargeable battery module 100 according to the present disclosure may be insertable in the human body. Since the ultrasonic rechargeable battery module 100 uses ultrasonic waves, even though the ultrasonic rechargeable battery module 100 is packaged by using a titanium alloy, vibration energy generated by the ultrasonic waves may be transmitted to the piezoelectric material inside the packaging through skin.

The exemplary embodiments disclosed in the specification of the present disclosure will not limit the present disclosure. The scope of the present disclosure will be interpreted by the claims below, and it will be construed that all techniques within the scope equivalent thereto belong to the scope of the present disclosure.

From the foregoing, it will be appreciated that various embodiments of the present disclosure have been described herein for purposes of illustration, and that various modifications may be made without departing from the scope and spirit of the present disclosure. Accordingly, various embodiments disclosed herein are not intended to be limiting, with the true scope and spirit being indicated by the following claims.

What is claimed is:

1. An ultrasonic rechargeable battery module, comprising:
a packaging including an accommodation part;
a reception vibration panel coupled to a peripheral portion of the packaging by using a flexible hinge to seal the packaging;
an ultrasonic wave receiving element formed in a lower surface of the reception vibration panel, and configured to convert vibration energy generated by ultrasonic waves to electric energy;
a circuit board formed inside the packaging, and configured to convert the electric energy converted by the ultrasonic wave receiving element to electric energy having a predetermined size; and
a secondary battery formed inside the packaging and configured to store the electric energy converted by the circuit board,
wherein the packaging, the flexible hinge, and the reception vibration panel are formed of a titanium alloy.

2. The ultrasonic rechargeable battery module of claim 1, wherein the ultrasonic wave receiving element comprises:
a piezoelectric element configured to convert vibration energy generated by ultrasonic waves to electric energy; and
a matching layer configured to assist vibration of the piezoelectric element through impedance matching.

3. The ultrasonic rechargeable battery module of claim 2, wherein a strain in a longitudinal direction of the flexible hinge and a strain in a translational direction of the flexible hinge are determined by a Poission's ratio of the piezoelectric element.

4. The ultrasonic rechargeable battery module of claim 2, wherein when the reception vibration panel is in direct contact with the piezoelectric element, the reception vibration panel is used as an electrode.

5. The ultrasonic rechargeable battery module of claim 2, wherein when the matching layer is a nonconductor, the reception vibration panel and the piezoelectric element is electrically connected by using an electric wire having a spring structure passing through a hole formed at a center of the matching layer.

6. The ultrasonic rechargeable battery module of claim 1, wherein the flexible hinge has a curvature shape or a zigzag shape.

7. The ultrasonic rechargeable battery module of claim 1, wherein the circuit board comprises:
a charging circuit unit configured to convert the electric energy converted by the ultrasonic wave receiving element to electric energy having a predetermined size;
an overcharge prevention circuit unit configured to prevent the secondary battery from being overcharged; and
a MICOM unit configured to transmit voltage information containing a voltage charged in the secondary battery and an amount of voltage charged in the secondary battery by using ultrasonic waves.

8. The ultrasonic rechargeable battery module of claim 1, wherein the charge circuit unit comprises:
a rectifier circuit configured to rectify the electric energy converted by the ultrasonic wave receiving element; and
a converter circuit configured to maintain the electric energy rectified by the rectifier circuit as electric energy having a predetermined size.

9. An ultrasonic rechargeable battery apparatus of a polyhedral structure, comprising:
a polyhedral structure in which an ultrasonic rechargeable battery module is formed in at least one surface,
wherein the ultrasonic rechargeable battery module comprises:
a packaging including an accommodation part;
a reception vibration panel coupled to a peripheral portion of the packaging by using a flexible hinge to seal the packaging;
an ultrasonic wave receiving element formed in a lower surface of the reception vibration panel, and configured to convert vibration energy generated by ultrasonic waves to electric energy;
a circuit board formed inside the packaging, and configured to convert the electric energy converted by the ultrasonic wave receiving element to electric energy having a predetermined size; and
a secondary battery formed inside the packaging and configured to store the electric energy converted by the circuit board,
wherein the packaging, the flexible hinge, and the reception vibration panel are formed of a titanium alloy.

10. The ultrasonic rechargeable battery apparatus of claim 9, wherein the ultrasonic wave receiving element comprises:
a piezoelectric element configured to convert vibration energy generated by ultrasonic waves to electric energy; and
a matching layer configured to assist vibration of the piezoelectric element through impedance matching.

11. The ultrasonic rechargeable battery apparatus of claim 10, wherein a strain in a longitudinal direction of the flexible hinge and a strain in a translational direction of the flexible hinge are determined by a Poission's ratio of the piezoelectric element.

12. The ultrasonic rechargeable battery apparatus of claim 9, wherein the flexible hinge has a curvature shape or a zigzag shape.

13. The ultrasonic rechargeable battery apparatus of claim 9, wherein the polyhedral structure further comprises an ultrasonic sensor configured to measure specific information by using ultrasonic waves in at least one surface thereof.

14. The ultrasonic rechargeable battery apparatus of claim 9, wherein the polyhedral structure further comprises an ultrasonic communication module configured to perform communication by using ultrasonic waves in at least one surface thereof.
